(19) United States
(12) Patent Application Publication
(10) Pub. No.: US 2010/0271909 A1
(43) Pub. Date: Oct. 28, 2010

(54) Perfect Egg Timer

(76) Inventor: Roger O. Michaelson, Centennial, CO (US)

Correspondence Address: Roger Michaelson, 5784 S. Killarney Way, Centennial, CO, 80015, US

(21) Appl. No.: 12/697,036

(22) Filed: Apr. 17, 2010

Related U.S. Application Data
(60) Provisional application No. 61/148,109, filed on Jan. 29, 2009.

(51) Int. Cl. G04F 10/00

(52) U.S. Cl. 368/108

(57) ABSTRACT

A timing device for the cooking of eggs, comprising timing means, apt to compute a temperature, signaling means, actuatable by the timing means to signal that the time interval has elapsed, and temperature sensitive means, apt to be arranged in proximity of the eggs and to determine the starting of computing of the time interval by the timing means at a pre-determined temperature.

This application emanates from a previously filed provisional application 61/148,109 filed on Jan. 29, 2009

### FIELD OF THE INVENTION

The present invention relates to a timer device, and in particular to a device for timing the cooking or heating of a food item.

### BACKGROUND OF THE INVENTION

Cooking or heating food to the exact degree of doneness can be a tricky and frustrating everyday task. For example, boiling eggs easily ends up in sloppy undercooked eggs or in rock-hard overcooked ones.

In order to simplify such task, timers are currently employed which the user switches on to start computing the cooking time.

These known-art timers suffer from some relevant drawbacks.

The main drawback lies in the fact that they rely on the person doing the cooking to begin the timing manually. This brings inconsistent results from time to time, because, depending on the heat source, on the cooking container used and in general on the cooking conditions, the food item to be cooked takes different times to reach the ideal cooking temperature.

Furthermore, in case of boiling, the person managing the timer has to wait for the water to boil to actuate the timer. This latter task is particularly annoying and frustrating, because it results in the necessity to wait and watch continuously the cooking container, instead of completing the meal preparation or doing other business. Moreover, it still leads to inconsistent results, because it is practically impossible to discriminate by looking when the water has reached the right temperature of actual full boiling.

When you cook soft-boiled eggs, they need to cook a precise length of time after the water starts boiling. (Some people use 3 minutes) The problem is, you get busy preparing the rest of the meal and suddenly notice that the water is boiling. Since you don't know exactly when the water started boiling, you have to guess as to how long to set the egg timer Consequently, when the timer goes off, the eggs are either too runny or too hard. With this invention, the timer, pre-set, by you, with your ideal cooking time, is started automatically just as the water starts boiling so your eggs are cooked perfectly is every time without having to notice when the water starts boiling.

### SUMMARY OF THE INVENTION

I have invented an egg timer where you can pre-set the length of time you would like the eggs to boil, when you place them on the stove. Rather than manually starting the egg timer, when you see the water starting to boil, the pre-set timer is activated and the countdown started, automatically, just as the water starts boiling. You simply set the timer with your ideal cooking time, clip the timer onto the edge of your cooking pan with the probe extending into the water, place the pan on the stove and forget it. When you hear the timer go off, your eggs will be cooked perfectly every time.

This invention would look similar to a digital thermometer with a clip to attach it to the side of a cooking pan. It would have a sensor, mounted on the end of a probe, which would extend into the water in the pan and an electronic countdown timer mounted on the top of the device. When the sensor, in the water, reaches a pre-determined temperature it will activate the connected pre-set timer just as the water starts boiling.

As an alternative, the sensor and electronic timer could be built-in to a pan, rather than clipping on the side.

### BRIEF DESCRIPTION OF DRAWINGS

FIG. 1 is the frontal view of the device.

FIG. 2 is the side view of the device

### DETAILED DESCRIPTION OF DRAWINGS:

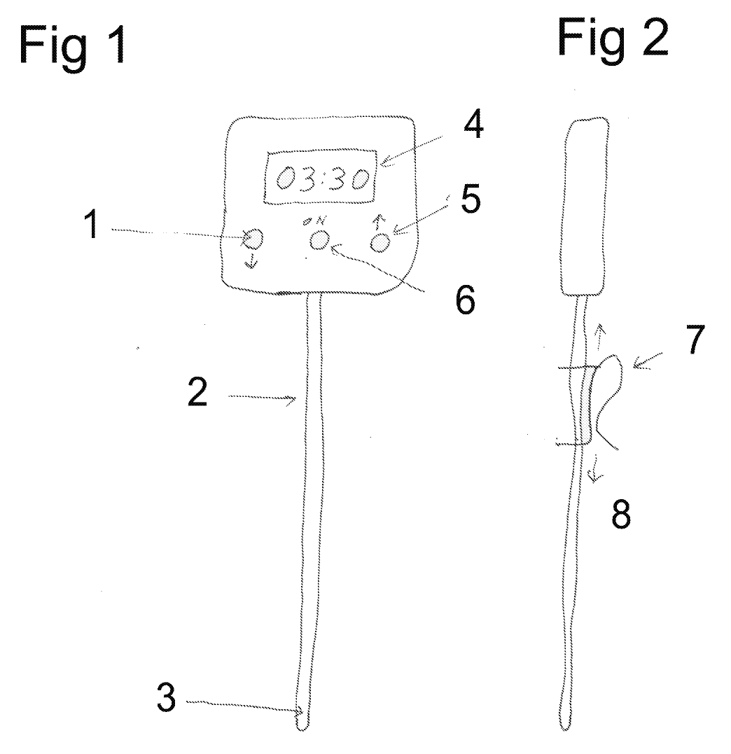

FIG. 1
1.Button used to reduce pre-set cooking time.
2. Metal probe to extend into cooking liquid (Similar to a meat thermometer probe.)
3.Temperature sensor enclosed in the end of the probe. This sensor will activate the pre-set timer just before the water reaches the boiling point. (Approximately 190 Degrees F to allow for use at any altitude.)
4. Digital display of pre-set cooking time.
5.Button used to increase pre-set cooking time.
6. Button used to turn timer on or off.

FIG. 2
7.Spring metal clip that slides up and down the metal probe, slips over the edge of the cooking pan, and allows you to adjust how far the metal probe extends into the cooking pan. (This feature allows you to use various size cooking pans.)
8. Side view.

I claim:

1. A perfect egg timer device comprised of a metal probe, electronic timer, digital display and working temperature sensor to operate in unison.

2. A perfect egg timer of claim 1 wherein; the metal probe is designed for sub surface use in water.

3. A perfect egg timer of claim 1 wherein; the temperature sensor is encased within the lower end of the probe, which is connected to and activates the pre-set timer.

4. A perfect egg timer of claim 1 wherein; the digital display allows for viewing and adjustment of cooking time.

5. A perfect egg timer of claim 1 wherein; a clip is embodied within the device to hold the timer to the edge of a cooking pot while adjusting the depth of the probe.

6. A perfect egg timer of claim 1 wherein; the probe is manufactured of water resistant materials.

7. A perfect egg timer of claim 1 wherein; the device embodies push buttons for pre-setting the cooking time.

8. A perfect egg timer of claim 1 wherein; the timer has an on/off button.
